(19) United States
(12) Patent Application Publication
(10) Pub. No.: US 2009/0079866 A1
(43) Pub. Date: Mar. 26, 2009

(54) Video Signal Oblique Interpolating Apparatus and Method

(75) Inventor: Toshiyuki Namioka, Tokorozawa-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/171,966

(22) Filed: Jul. 11, 2008

(30) Foreign Application Priority Data
Sep. 21, 2007 (JP) 2007-246003

(51) Int. Cl. H04N 7/01

(52) U.S. Cl. 348/443

(57) ABSTRACT

A data interpolation apparatus at intermediate pixels between upper and lower pixels. An upper oblique correlation is calculated between data of an immediate upper pixel and a corresponding lower pixel positioned downward in a maximum correlation direction with respect to the immediate upper pixel. A lower oblique correlation is similarly calculated between data of an immediate lower pixel and a corresponding upper pixel. An interpolation signal is obtained by mixing an oblique pixel sum and a vertical pixel sum, while changing mixing ratio based on a comparison of a vertical correlation, and the upper and lower oblique correlation. When the interpolation signal is constituted without the vertical pixel sum, an interpolation signal with respect to intermediate pixels immediate upward/downward of the corresponding lower/upper pixel is generated by excluding a vertical sum that includes data of the corresponding upper and/or lower pixels.

### CROSS-REFERENCE TO RELATED APPLICATIONS

This application is based upon and claims the benefit of priority from Japanese Patent Application No. 2007-246003, filed Sep. 21, 2007, the entire contents of which are incorporated herein by reference.

### BACKGROUND

1. Field

The present invention is related to a video signal oblique interpolating apparatus and a video signal oblique interpolating method, which are applied to a video signal scaling apparatus for performing either a compressing process operation or an expanding process operation of a pixel number with respect to a video signal along either a horizontal direction or a vertical direction.

2. Description of Related Art

Currently, various formats have been practically utilized for video signals, such as the format of the NTSC (National Television System Committee) television system, the format of the PAL (Phase Alternation by Line) color television system, and the format for the high deification television system and video signals for personal computers.

When video signals of those formats are employed to display videos on display apparatuses such as liquid crystal displays and plasma displays, it is necessary to compress or expand pixel counts of these video signals along either the horizontal direction or the vertical direction in accordance with the pixel counts of the display apparatuses.

Such an apparatus for performing compressing or expanding process on a video signal is called as a video signal scaling apparatus.

In the case that an expanding process is carried out with respect to a video signal by a video signal scaling apparatus, when the video signal includes an edge portion along an oblique direction (will also be referred to as “oblique edge”) is displayed, the video signal scaling apparatuses may simply increase pixels in consideration of a difference in the horizontal direction or in the vertical direction. Then, a jaggy stepped portion may appear in the oblique edge.

As a consequence, in the video signal scaling apparatus, an oblique interpolating apparatus for interpolating proper pixels by considering a correlative relationship among the pixels along the oblique direction has been provided in order to eliminate the jaggy portion in such oblique edges.

As a conventional apparatus executing oblique interpolation, for instance, a scanning line interpolating apparatus as disclosed in JP-A-4-364685 has been proposed. In this scanning line interpolating apparatus, an oblique interpolating operation is carried out as follows: First, both a video signal and a delay signal are inputted. The delay signal is produced by delaying the video signal by 1 horizontal scanning period Next, both an absolute difference value between pixels arranged along an upper/lower direction, and an absolute difference value between pixels arranged along an oblique direction are calculated. Then, an oblique direction determining circuit determines a pixel having the largest correlation based on the respective absolute difference values. Finally, an oblique pixel summing circuit produces an interpolation pixel by employing the determined pixel, and then, an oblique interpolating operation is carried out by employing the produced interpolation pixel. In addition, oblique interpolating operations have been described in WO 2004-17634, JP-A-2002-1859346, JP-A-2001-94951, etc.

In the scanning line interpolating apparatus disclosed in JP-A-4-364685, a compulsory upper/lower interpixel switching circuit is provided between the oblique direction determining circuit and the oblique summing circuit. When an edge is not detected from pixels of both lines where the oblique interpolation is carried out, the oblique direction determining signal is compulsorily switched to the upper/lower interpixel sum so as to produce an interpolation pixel.

However, in the scanning line interpolating apparatus disclosed in JP-A-4-364685, the determination is made in the binary manner as to whether or not the oblique edge is present with respect to the video signals having the oblique edges, and then, the oblique pixel sum is compulsorily switched to the upper/lower interpixel sum based on the determination. As a result, in this scanning line interpolating apparatus, when the video signals are very close to a threshold value of such a determination, the oblique pixel sums and the upper/lower interpixel sums are continuously switched one after another. Consequently, quality of the videos may be deteriorated.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a configuration of a video signal oblique interpolating apparatus according to an embodiment;

FIG. 2 is a diagram indicating detection directions of oblique correlation detected by the video signal oblique interpolating apparatus;

FIG. 3 is a diagram representing one example of a video signal, a 1-H delay signal, and an interpolation signal;

FIG. 4 is a diagram showing another example of a video signal, a 1-H delay signal, and an interpolation signal;

FIG. 5 is a diagram showing one example of a video signal a 1-H delay signal, and an interpolation signal, which display a picture having an oblique edge whose gradient is gentle; and

FIG. 6 is a diagram showing another example of a video signal, a 1-H delay signal, and an interpolation signal, which display a picture having an oblique edge whose gradient is gentle.

### DETAILED DESCRIPTION

Various embodiments according to the invention will be described hereinafter with reference to the accompanying drawings. In general, according to one embodiment of the invention, a video signal oblique interpolating apparatus for interpolating data at an intermediate pixel between pixels, includes: an upper/lower oblique correlation detecting unit configured to calculate an upper oblique correlation and a lower oblique correlation, the upper oblique correlation being calculated between data of an upper pixel and data of a corresponding lower pixel, the upper pixel positioned at an upper side of the intermediate pixel, the corresponding lower pixel that is positioned obliquely lower to the intermediate pixel and whose data shows a maximum correlation to the data of the upper pixel, the lower oblique correlation being calculated between data of a lower pixel and data of a corresponding upper pixel, the lower pixel positioned at a lower side of the intermediate pixel, the corresponding upper pixel that is positioned obliquely upper to the intermediate pixel and whose data shows maximum correlation to the data of the lower pixel; and an interpolation signal outputting unit configured to output an interpolation signal with respect to the intermediate pixel, the interpolation signal obtained by mixing a first oblique pixel sum, a second oblique pixel sum and a vertical pixel sum, the first oblique pixel sum obtained by summing data with respect to the upper pixel and the corresponding lower pixel, the second oblique pixel sum obtained by summing data with respect to the lower pixel and the corresponding lower pixel, the vertical pixel sum obtained by summing data with respect to the upper pixel and the lower pixel; wherein the interpolation signal outputting unit generates the interpolation signal by mixing the first oblique pixel sum and the second oblique pixel sum while excluding the vertical pixel sum in a given condition.

Common reference numerals will be employed to denote common structural elements, and duplicate descriptions thereof will be omitted.

### Configuration of Video Signal Oblique Interpolating Apparatus

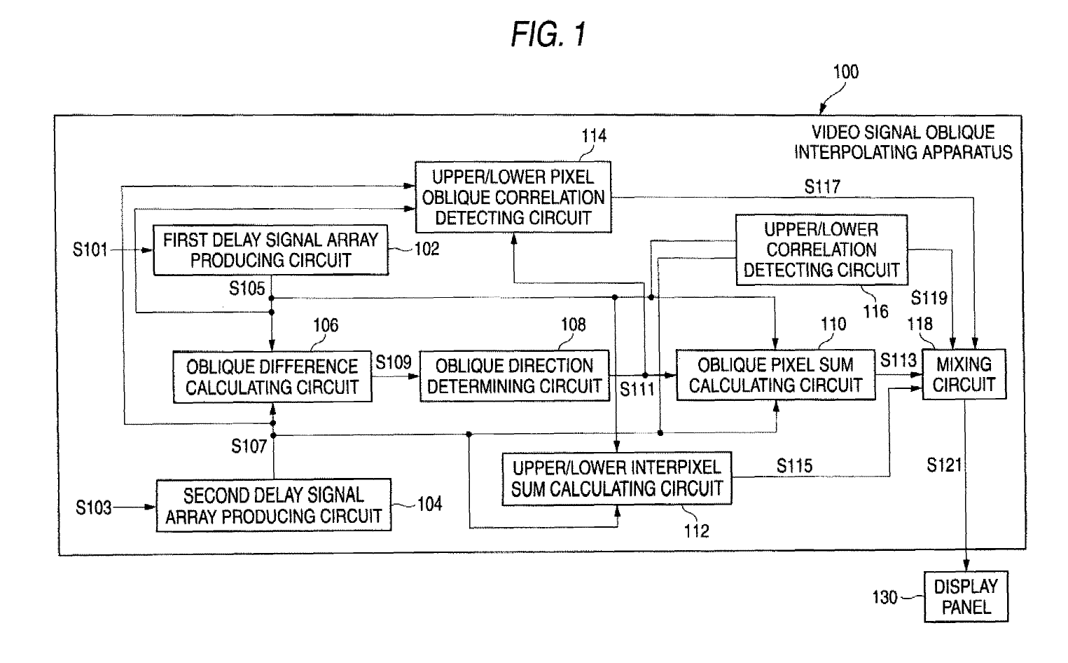

FIG. 1 is a block diagram showing a configuration of a video signal oblique interpolating apparatus 100 according to an embodiment of the invention. The video signal interpolating apparatus 100 is assembled in a video signal scaling apparatus (not shown). Both a video signal S101 entered to the above-described video signal scaling apparatus and a 1-H delay signal S103 are inputted into the video signal oblique interpolating apparatus 100. The 1-H delay signal S103 is generated by delaying the video signal S101 by one horizontal scanning period (1H). Also, the video signal oblique interpolating apparatus 100 is configured to generate and output an interpolation signal S121 using the video signal S101 and the 1-H delay signal S103.

Further, a display panel 130 is connected to the video signal oblique interpolating apparatus 100. The video signal oblique interpolating apparatus 100 outputs the interpolation signal S121 to the display panel 130. The video signal oblique interpolating apparatus 100 functions as a display control means, and controls a display of a video on the display panel 130 using the interpolation signal S121. The display panel 130 displays thereon the picture by employing the interpolation signal S121.

The video signal oblique interpolating apparatus 100 includes a first delay signal array producing circuit 102, a second delay signal array producing circuit 104, an oblique difference calculating circuit 106, and an oblique direction determining circuit 108. Also, the video signal oblique interpolating apparatus 100 includes an oblique pixel sum calculating circuit 110, an upper/lower interpixel sum calculating circuit 112, an upper/lower pixel oblique correlation detecting circuit 114, an upper/lower correlation detecting circuit 116, and a mixing circuit 118.

The video signal S101 and the 1-H delay signal S103 are inputted to the first and second delay signal array producing circuits 102 and 104, respectively. Also, while each of the first and second delay signal array producing circuits 102 and 104 contains a plurality of delay taps, the first delay signal array producing circuit 102 outputs a first delay signal array S105 by employing the respective delay taps, and the second delay signal array producing circuit 104 outputs a second delay signal array S107 by employing the respective delay taps. Both the first delay signal array S105 and the second delay signal array S107 are inputted to the oblique difference calculating circuit 106, the oblique pixel sum calculating circuit 110, the upper/lower interpixel sum calculating circuit 112, the upper/lower pixel oblique correlation detecting circuit 114, and the upper/lower correlation detecting circuit 116.

The oblique difference calculating circuit 106 inputs the first delay signal array S105 and the second delay signal array S107, and calculates an absolute value of a plurality of differences along an oblique direction in order to detect correlation along the oblique direction (namely, oblique correlation) as to both the first and second delay signal arrays S105 and S107. Then the oblique difference calculating circuit 106 outputs to the oblique direction determining circuit 108 the calculated data indicating the difference absolute value as oblique difference absolute value data S109.

The oblique direction determining circuit 108 inputs the oblique difference absolute value data S109 so as to acquire oblique correlation between the first delay signal array S105 and the second delay signal array S107 based on the oblique difference absolute value data S109. Also, the oblique direction determining circuit 108 functions as an oblique direction detecting unit capable of detecting a maximum correlation direction based upon the acquired oblique correlation, and outputs an oblique direction determination signal S111 indicating the detection result. This oblique direction determination signal S111 is entered to the oblique pixel sum calculating circuit 110 and the upper/lower pixel oblique correlation detecting circuit 114.

The oblique pixel sum calculating circuit 110 calculates a sum of the respective oblique pixels from the first delay signal array S105 and the second delay signal array S107 in accordance with the oblique direction determination signal S111 in the maximum correlation oblique direction, which is determined to show the maximum correlation. Then, the oblique pixel sum calculating circuit 110 outputs the calculated oblique pixel sum as an oblique pixel sum signal S113.

The upper/lower interpixel sum calculating circuit 112 calculates a sum of upper and lower interpixels by employing the first delay signal array S105 and the second delay signal array S107, and then, outputs the calculated upper/lower interpixel sum as an upper/lower interpixel sum signal S115.

The upper/lower oblique correlation detecting circuit 114 functions as an upper/lower correlation detecting unit, and detects upper oblique correlation and lower oblique correlation (both oblique correlation will be explained later) along the high correlation oblique direction based on a result (namely, oblique direction determination signal S111) detected by the oblique direction determining circuit 108, and then, outputs an upper/lower pixel oblique correlation signal S117 in response to the detected result. The detections of both the upper-sided oblique correlation and the lower-sided oblique correlation, which are carried out by the upper/lower pixel oblique correlation detecting circuit 114, will be referred to as “upper/lower oblique correlation detections”, which will be later described more in detail.

The upper/lower correlation detecting circuit 116 calculates a difference of respective pixels along the upper/lower direction by employing the first delay signal array S105 and the second delay signal array S107, and on the other hand, detects upper/lower correlation from the calculated difference, and then, outputs an upper/lower correlation detection signal S119 indicative of this detected upper/lower correlation.

The mixing circuit 118 functions as an interpolation signal outputting unit, and inputs the oblique pixel sum signal S113, the upper/lower interpixel sum signal S115, the upper/lower pixel oblique correlation signal S117, and the upper/lower correlation detection signal S119 so as to output an interpolation signal S121. This interpolation signal S121 is generated by mixing the oblique pixel sum signal S113 with the upper/lower interpixel sum signal S115 in response to the upper/lower pixel oblique correlation signal and the upper/lower correlation detection signal S119.

### Operation of Video Signal Oblique Interpolating Apparatus

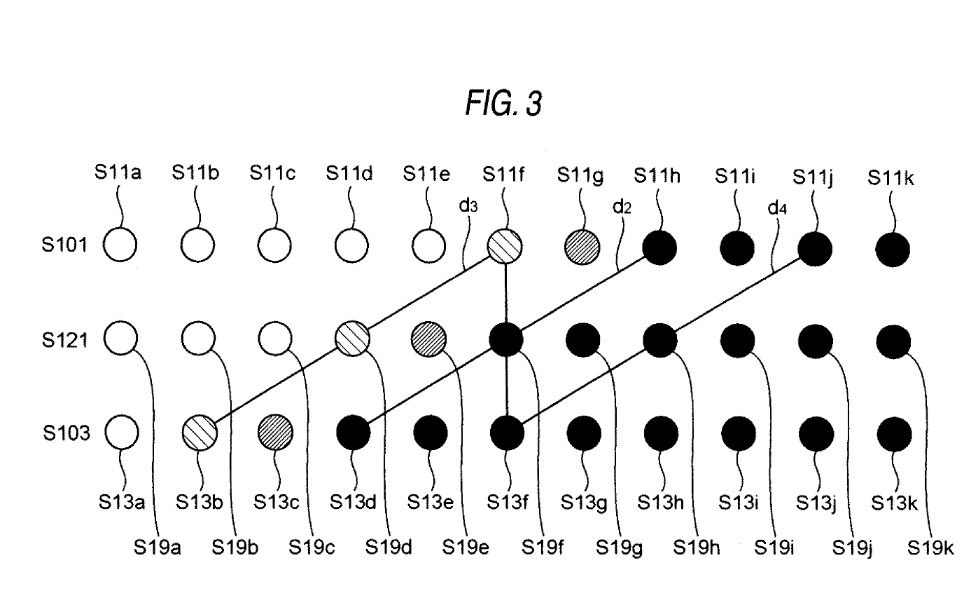

Next, the operation of the video signal oblique interpolating apparatus 100 will be explained. Here, an exemplified explanation is made with respect to a case in which a video signal S101 having an oblique edge and a 1-H delay signal S103, as shown in FIG. 3, are entered into the video signal oblique interpolating apparatus 100. At this time, the video signal oblique interpolating apparatus 100 is operated as below to generate an interpolation signal S121.

The video signal S101 and the 1-H delay signal S103 are displayed on pixels as shown in FIG. 3. The video signal S101 contains eleven (11) pieces of pixels defined from S11a to S11k. Among these pixels, for example, five (5) pieces of the pixels S11a, S11b, S11c, S11d, and S11e are white having the same brightness; one piece of the pixel S11f is light gray; 1 piece of the pixel S11g is gray; 1 piece of the pixel S11h is dark gray; and three (3) pieces of the pixels S11i, S11j, and S11k are black having the same brightness.

The 1-H delay signal S103 has pixels from S13a to S13. The brightness of the pixels are varied as follows: the pixel S13a is white; the pixel S13b is light gray; the pixel S13c is gray; the pixel S13d is dark gray; and the pixels S13e, S13f, S13g, S13h, S13i, S13j, and S13c are black having the same brightness. When a video is displayed by using the video signal S101 and the 1-H delay signal S103, the video includes an oblique edge having a boundary between the pixel S11f and the pixel S13b.

When the video signal S101 and the 1-H delay signal S103 are input to the first delay signal array producing circuit 102 and the second delay signal array producing circuit 104, a first delay signal array S105 and a second delay signal array S107 are generated and entered into the oblique difference calculating circuit 106.

The oblique difference calculating circuit 106 calculates absolute difference values between pixels arranged along a plurality of oblique directions based upon the first delay signal array S105 and the second delay signal array S107, and outputs the calculated absolute values as oblique difference absolute value data S109.

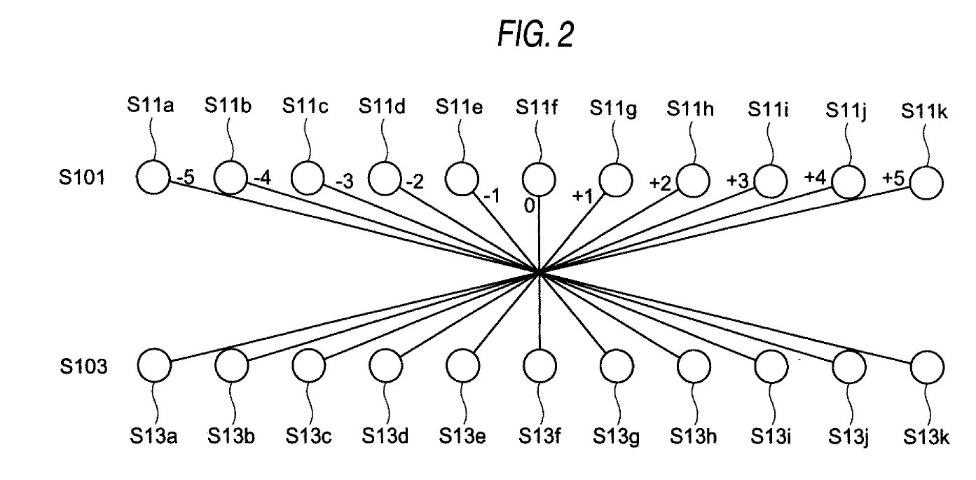

As shown in FIG. 2, the oblique difference calculating circuit 106 calculates absolute values of differences between pixels with respect to a plurality of pixels S11a to S11k included in the video signal S101, and a plurality of pixels S13a to S13k included in the 1-H delay signal S103. The calculation is done with respect to pixels that are arranged obliquely (or vertically), such as “S11a and S13k”, “S11b and S13j”, “S11c and S13i”, - - - , “S11k and S13a”.

As a consequence, as shown in FIG. 2, the oblique difference calculating circuit 106 calculates the absolute difference values between the pixels arranged along 11 sorts of oblique directions defined from “−5” up to “+5.”

When the oblique difference absolute value data S109 is input into the oblique direction determining circuit 108, the maximum correlation direction is detected from eleven (11) sorts of the oblique directions (shown in FIG. 2) as a high correlation direction based on the difference absolute value calculated by the oblique difference calculating circuit 106. Then, the oblique direction determining circuit 108 outputs an oblique direction determination signal S111.

Here, the video signal S101 and the 1-H delay signal S103 are configured by the pixels as shown in FIG. 3, the correlation between the pixel “S11h” and the pixel “S13d” is large. As a result, the oblique direction determining circuit 108 determines an oblique direction “d2” as the high correlation oblique direction, and thus, outputs an oblique direction determination signal S111.

Since the oblique pixel sum calculating circuit 110 calculates an oblique pixel sum in accordance with the oblique direction determination signal S111, the oblique pixel sum calculating circuit 110 calculates oblique pixel sums of respective pixels along the oblique direction “d2”, which includes an oblique pixel sum between the pixel S11h and the pixel S13d. By this, the oblique pixel sum calculating circuit 10 outputs the oblique pixel sum signal S113.

Since the upper/lower interpixel sum calculating circuit 112 calculates an upper/lower interpixel sum as to the respective pixels based on the first delay signal array S105 and the second delay signal array S107, the upper/lower interpixel sum calculating circuit 112 calculates a sum between upper pixels and lower pixels as to the video signal S101 and the 1-H delay signal S103. For instance, a sum between the upper pixel S11a and the lower pixel S13a; the upper pixel S11b and the lower pixel S13b; the upper pixel S11c and the lower pixel S13c; - - - , the upper pixel S11k and the lower pixel S13k, are calculated and outputted as an upper/lower interpixel sum signal S115.

The upper/lower pixel oblique correlation detecting circuit 114 performs an upper/lower oblique correlation detecting operation as follows: Since the direction determined as the high correlation oblique direction by the oblique direction determining circuit 108 is the oblique direction “d2”, assuming now that a pixel arranged at an interpolation position between the pixel “S11h” and the pixel “S13d” is defined as an interpolation pixel, the pixel “S19f” becomes the interpolation pixel.

Then, the upper/lower pixel oblique correlation detecting circuit 114 detects correlation as viewed from the pixel “S11f” positioned on the upper side of the interpolation pixel “S19f” and the pixel “S13f” positioned on the lower side thereof along the same direction as the oblique direction “d2” (pixel positioned on upper side of interpolation pixel will be referred to as “upper-sided pixel”, and pixel positioned on lower side thereof will be referred to as “lower-sided pixel”).

In this case, since the interpolation pixel in the oblique direction “d2” is the pixel S19f the upper-sided pixel becomes the pixel “S11f”, whereas the lower-sided pixel becomes the pixel “S13f” Then, the same oblique direction as the oblique direction “d2” as viewed from the upper-sided pixel S11f is an oblique direction “d3”, whereas the same oblique direction as the oblique direction “d2” as viewed from the lower-sided pixel S13f is an oblique direction “d4.” Below, the same oblique direction as the high correlation direction (namely, oblique direction “d2” in the above) as viewed from the upper pixel will be referred to as an upper oblique direction, whereas the same oblique direction as the oblique direction “d2” as viewed from the lower pixel will be referred to as a lower oblique direction. Also, correlation of the upper-sided oblique direction will be referred to as upper oblique correlation, whereas correlation of the lower oblique direction will be referred to as lower oblique correlation.

As shown in FIG. 3, the upper oblique correlation is a correlation between the upper-sided pixel “S11f” and the lower-sided pixel “S13b”, which are arranged along the oblique direction “d3”. Also, the lower oblique correlation is a correlation between the upper pixel “S11j” and the lower pixel “S13f”, which are arranged along the oblique direction “d4.” Both of the upper correlation and the lower correlation are determined as being high.

The upper/lower pixel oblique correlation detecting circuit 114 detects both upper oblique correlation and lower oblique correlation with respect to the oblique directions “d3” and “d4”, and then, outputs an upper/lower pixel oblique correlation signal S117 in response to the detection results. In addition, since the upper oblique correlation and the lower oblique correlation are varied in accordance with the pixel of the video signal S101 and the pixel of the 1-H delay signal S103, the upper/lower pixel oblique correlation signal S117 includes data that indicate both of the upper oblique correlation and the lower oblique correlation (Hereinafter, these correlations will be collectively referred to as “upper/lower oblique correlation”).

Then, the mixing circuit 118 changes a ratio of mixing the oblique pixel sum signal S113 with the upper/lower interpixel sum signal S115 in accordance with the upper/lower pixel oblique correlation signal S117 and the upper/lower pixel detection signal S119 so as to produce an interpolation signal S121. In this case, the mixing circuit 118 functions as a comparing unit, which compares the upper/lower oblique correlation indicated by the upper/lower pixel oblique correlation signal S117 with the upper/lower correlation indicated by the upper/lower correlation detection signal S119. In accordance with the comparison result, the mixing ratio of the oblique pixel sum signal S113 and the upper/lower interpixel sum signal S115 are changed.

That is, in the mixing circuit 118, as the upper/lower oblique correlation becomes higher than the upper/lower correlation, the oblique pixel sum tends to be outputted. Specifically, when the upper/lower oblique correlation is higher than the upper/lower correlation, the oblique pixel sum signal S113 is outputted more preferentially than the upper/lower interpixel sum signal S115. Also, the mixing circuit 118 is configured so that the upper/lower interpixel sum signal S115 is gradually outputted in addition to the oblique pixel sum signal S113, as the upper/lower oblique correlation becomes lower. When the upper/lower oblique correlation becomes lower than the upper/lower correlation, the upper/lower interpixel sum signal S115 is preferentially outputted, as compared with the oblique pixel sum signal S113.

In this embodiment, when the upper/lower oblique correlation is compared with the upper/lower correlation, the correlation as to the oblique directions “d3” and “d4” is also high in addition to the oblique direction “d2”. In contrast, since there is no correlation between the upper pixel S11f and the lower pixel S13f, the upper/lower correlation is low. Accordingly, the oblique pixel sum signal S113 is more preferentially outputted than the upper/lower interpixel sum signal S115, so that the oblique pixel sum signal S113 is outputted as the interpolation signal S121 (namely, pixel S19f is generated from oblique sum of the pixel S11h and the pixel S13d).

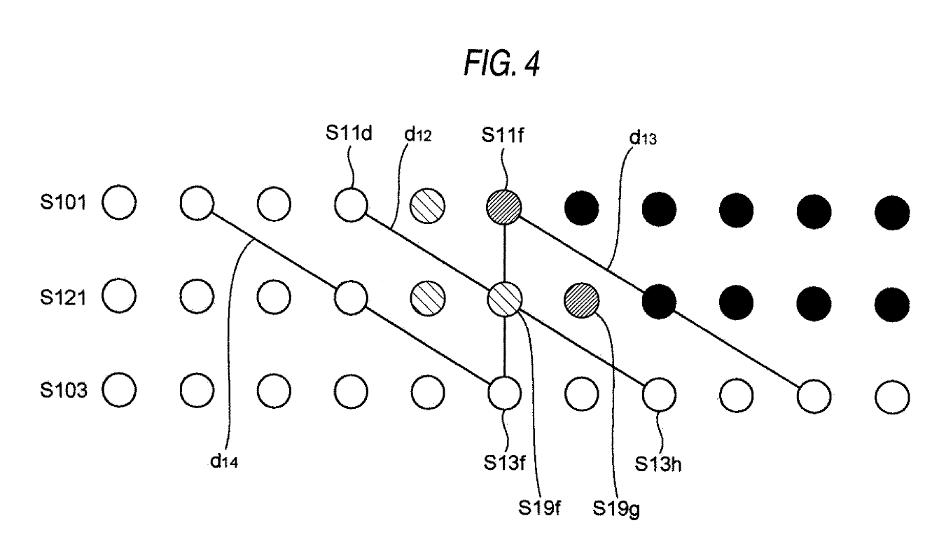

FIG. 4 is a diagram illustratively showing a video signal S101 and a 1-H delay signal S103, assuming that a boundary line appears at a break such as a corner of a rectangular object. In this case, the high correlation oblique direction detected by the oblique direction determining circuit 108 is indicated as an oblique direction “d12.”

However, as shown in FIG. 4, since the 1-H delay signal S103 corresponds to pixels where the object is not displayed, there should be no correlation between the video signal S101 and the 1-H delay signal S103 even along any oblique directions. Although the high correlation oblique direction is the oblique direction “d12”, outputting the interpolation signal S121 as an oblique pixel sum results in appearance of inappropriate interpolation pixels in the vicinity of the break. As a result, the object displayed in the video may lack its corner.

On the other hand, when an oblique edge is gentle, there are some possibilities that this gentle oblique edge is not detected. In the conventional scanning line interpolating apparatus disclosed in JP-A-4-364685, there are some cases that the oblique pixel sum and the upper/lower interpixel sum are continuously switched one after another, depending upon whether or not the edge is detected.

However, in the video signal oblique interpolating apparatus 100 according to the embodiment, the video signal S101 and the 1-H delay signal S103 shown in FIG. 4 are treated as follows.

In FIG. 4, the high correlation oblique direction corresponds to the oblique direction “d12”. An interpolation pixel is “S19f”, an upper pixel is “S11f”; and a lower pixel is “S13f.” Accordingly, the corresponding oblique direction to the oblique direction “d12” as viewed from the upper pixel “S11f” is an oblique direction “d13”, whereas the corresponding oblique direction to the oblique direction “d12” as viewed from the lower pixel “S13f” is an oblique direction d14.”

Although it is observed that the correlation of the oblique direction “d14” is high so that the lower oblique correlation exists, the correlation of the oblique direction “d13” is low and it is not observed that the upper oblique correlation exists. On the other hand, since the correlation as to the upper pixel “S11f” and the lower pixel “13f” is low, the upper/lower correlation between the upper pixel S11f and the lower pixel S13f is considered to be the same or similar to the upper oblique correlation so that there is no difference between them.

In other words, both of the upper oblique correlation and the upper/lower correlation are low so that it is not observed any superiority to each other. As a consequence, assuming now that there is no oblique correlation, the mixing circuit 118 gives a priority to the upper/lower interpixel sum, and then, outputs the upper/lower interpixel signal S115 as the interpolation signal S121.

As described above, in the video signal oblique interpolating apparatus 100, the mixing circuit 118 generates the interpolation signal S121 by mixing the oblique pixel sum signal S113 with the upper/lower interpixel signal S115, and outputs this interpolation signal S121. As a result in the video signal oblique interpolating apparatus 100, the oblique pixel sum signal S113 and the upper/lower interpixel sum signal S115 are not continuously switched from one after another to be outputted, so that the quality of the video displayed is not deteriorated.

Also, in response to the upper/lower pixel oblique correlation signal S117 and the upper/lower correlation detection signal S119, the mixing circuit 118 changes the mixing ratio between the oblique pixel sum signal S113 and the upper/lower interpixel sum signal S115 so as to produce the interpolation signal S121. Since the interpolation signal S121 may be adapted to the higher correlation between the oblique correlation and the upper/lower correlation, the quality of the video may be increased in this regard.

Furthermore, the mixing circuit 118 is configured so that as the upper/lower oblique correlation becomes higher as compared to the upper/lower correlation, the oblique pixel sum tends to be more preferentially outputted. Accordingly, the interpolation pixel is produced based upon the oblique pixel sum when the oblique correlation is high, so that the quality of the video may also be increased in this regard.

Next, an operation of the video signal oblique interpolating apparatus 100 is described with respect to a case where a video signal is inputted for a video including an oblique edge whose gradient is gentle.

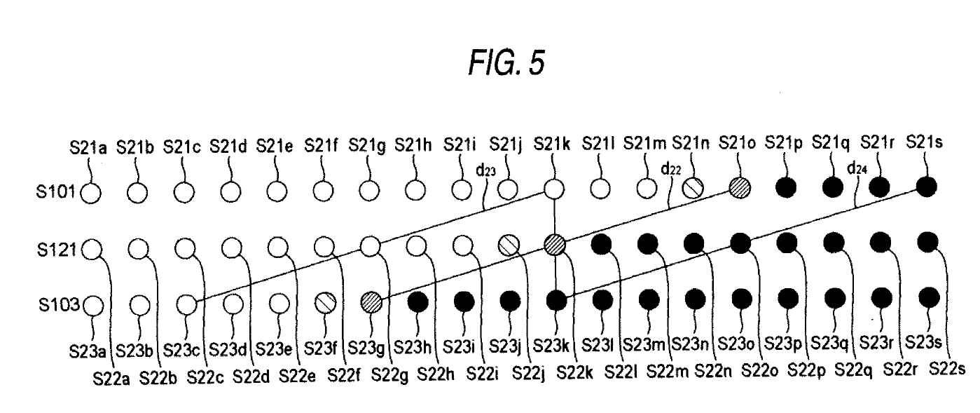

In this exemplified case, both a video signal S101 and a 1-H delay signal S103 as shown in FIG. 5 are entered into the video signal oblique interpolating apparatus 100. At this time, the video signal oblique interpolating apparatus 100 is operated as below so as to produce an interpolation signal S121.

The video signal S101 shown in FIG. 5 contains nineteen (19) pixels from S21a up to S21s. Among these pixels, for instance, thirteen (13) pixels of S21a, S21b, S21c, S21d, S21e, S21f, S21g, S21h, S21i, S21j, S21k, S21l, and S21m are white having the same brightness; the pixel S21n is light gray; the pixel S21o is gray; the pixel S21p is dark gray; and also, three pixels of S21q, S21r, S21s are black having the same brightness.

In the 1-H delay signal S103, the brightness of pixels is varied from S23a to S23c. The pixels S23a, S23b, S23c, S23d, S23e are white; the pixel S23f is light gray; the pixel S23g is gray; the pixel S23h is dark gray; and also, eleven (11) pixels S23i, S23j, S23k, S23l, S23m, S23n, S23o, S23p, S23q, S23r, S23s are black having the same brightness.

When a video is played using the video signal S101 and 1-H delay signal S103, a picture having an oblique edge whose gradient is gentle is displayed, while the pixel S21n and the pixel S23f become a boundary.

The video signal oblique interpolating apparatus 100 is operated in a similar manner as above, when the video signal shown in FIG. 5 is inputted. Accordingly, the interpolation signal S121 is outputted from the mixing circuit 118 as follows.

At this time, the oblique difference calculating circuit 106 calculates oblique absolute values between pixels having positional relationships where the pixels are arranged along oblique directions (otherwise, along upper/lower direction), as to the plurality of pixels S21a to S21s included in the video signal S101, and the plurality of pixels S23a to S23s included in the 1-H delay signal S103. Then, the oblique difference calculating circuit 106 outputs oblique difference absolute value data S109.

The oblique direction determining circuit 108 enters the oblique difference absolute value data S109 so as to detect the maximum correlation direction from nineteen (19) sorts of oblique directions as a high correlation oblique direction, and then, outputs the detected high correlation oblique direction as oblique direction determination signal S111. In this case, since the correlation between the pixel S21o and the pixel S23g is high, the oblique direction determining circuit 108 determines such an oblique direction “d22” shown in FIG. 5 as the high correlation oblique direction, and then, outputs the oblique direction determination signal S111.

Also, the oblique pixel sum calculating circuit 110 calculates sums of respective pixels along the oblique direction “d22”, namely, calculates oblique pixel sums about the respective pixels, which include an oblique pixel sum between the pixel S21o and the pixel S23g along the oblique direction “d22”. Then, the oblique pixel sum calculating circuit 110 outputs an oblique pixel sum signal S113.

Furthermore, the upper/lower interpixel sum calculating circuit 112 calculates upper/lower interpixel sums between the video signal S101 and the 1-H delay signal S103 by respectively summing the pixels S21a and S23a, the pixels S21b and S23b, the pixels S21c and S23c, - - - , the pixels S21s and S23s. Then, the upper/lower interpixel sum calculating circuit 112 outputs an upper/lower interpixel sum signal S115.

In the case of the video signal S101 and the 1-H delay signal S103 shown in FIG. 5, when an interpolation pixel is “S22k”, an upper pixel becomes “S21k” and a lower pixel becomes “S23k.” As a consequence, the oblique direction as viewed from the upper pixel “S21k” corresponding to “d22” becomes an upper oblique direction “d23”, whereas the oblique direction as viewed from the lower pixel “23k” corresponding to “d22” becomes a lower oblique direction “d24.”

As a result, as shown in FIG. 5, the upper oblique correlation becomes a correlation between the upper pixel “S21k” and the lower pixel “S23c” which are arranged along the oblique direction “d23”, whereas the lower oblique correlation becomes a correlation between the upper pixel “S21s” and the lower pixel “S23k” which are arranged along the oblique direction “d24.” It is determined that either of the upper oblique correlation and the lower oblique correlation is high.

The upper/lower pixel oblique correlation detecting circuit 114 detects both the upper oblique correlation and the lower oblique correlation with respect to the oblique directions “d23” and “d24”, and then, outputs an upper/lower pixel oblique correlation signal S117 in response to the detection result.

Also, the upper/lower correlation detecting circuit 116 calculates differences of the respective pixels along the upper/lower direction by using the first delay signal array S105 and the second delay signal array S107, and detects upper/lower correlation from the calculated differences, and then, outputs an upper/lower correlation detection signal S119 indicative of the detected upper/lower correlation.

Further, the mixing circuit 118 changes a ratio of mixing the oblique pixel sum signal S113 with the upper/lower interpixel sum signal S115 in response to the upper/lower pixel oblique correlation signal S117 and the upper/lower correlation detection signal S119 in the above-described manner so as to produce an interpolation signal S121.

In this case, the mixing circuit 118 performs an operation of comparing the upper/lower oblique correlation indicative of the upper/lower pixel oblique correlation signal S117 with the upper/lower correlation indicative of the upper/lower correlation detection signal S119, while functioning as a comparing unit. In the case of FIG. 5, in addition to the oblique direction “d22”, correlations as to the upper oblique direction “d23” and the lower oblique direction “d24” are high. In contrast since there is no correlation between the upper pixel “S21k” and the upper pixel “S23k”, the upper/lower correlation is low.

As a consequence, the oblique pixel sum signal S113 is preferentially selected over the upper/lower interpixel sum signal S115, so that the oblique pixel sum signal S113 is outputted as the interpolation signal S121.

In this case, for example, an interpolation pixel “S22k” is generated from the oblique pixel sum between the pixel “S21o” and the pixel “S23g.” Similarly, an interpolation pixel “S22j ” is generated from the oblique pixel sum between the pixel “S21m” and the pixel “S23f.” Then, an oblique edge appears in the interpolation signal S121 at the interpolation pixel “S22j”. In this case, a line that connects the pixels S21n, S22j, and S22f with each other becomes gentler than that of the case shown in FIG. 3, so that a video having the oblique edge that is gentle in gradient will be displayed.

On the other hand, since the interpolation signal S121 is generated by mixing the oblique pixel sum signal S113 with the upper/lower interpixel sum signal S115, the interpolation pixel is formed from any one, or both of the oblique pixel sum and the upper/lower interpixel sum.

Also, the respective pixels which constitute the video signal S101 and the 1-H delay signal S103 are also employed so as to produce the upper/lower interpixel sum in addition to the oblique pixel sum. As a consequence, for instance, in the case that the interpolation pixel “S22k” is produced only from the oblique pixel sum between two pixels of the pixel “S21o” and the pixel “S22g”, in other words, even when the upper/lower interpixel sum is not employed in order to produce the interpolation pixel “S22k”, the pixel S23g will be employed to obtain an oblique pixel sum in the oblique direction “d22” along with the pixel “21o”, and furthermore, to obtain an upper/lower interpixel sum along with the pixel S21g.

However, in the case that the interpolation pixel “S22k” is produced from only the oblique pixel sum of the pixels “S21o” and “S23g”, assume that the upper/lower interpixel sum using the same pixel “23g” is mixed with the oblique pixel sum so as to output the interpolation signal S121.

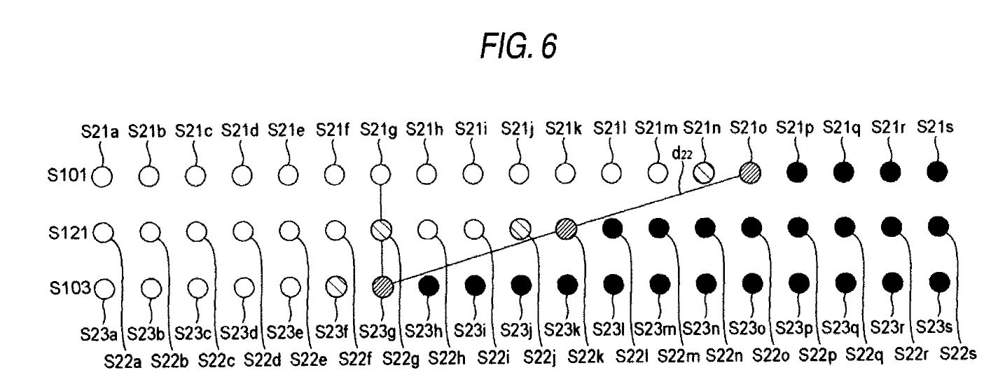

Then, the interpolation pixel 22g is produced from the oblique pixel sum between the pixels “S21k” and “S23c”. While the interpolation pixel S22g should become white as indicated in FIG. 5, the interpolation pixel S22g becomes light gray as shown in FIG. 6, since the upper/lower interpixel sum using the pixel “S23g” (namely, upper/lower interpixel sum between pixel S21g and pixel S23g) is mixed with the oblique pixel sum.

In other words, when the interpolation pixel “S22k” is formed by using only two pixels of the pixels “S23g” and “S21o” (namely, oblique pixels) which form the oblique pixel sum along the high correlation oblique direction “d22”, if the upper/lower interpixel sum using only one of these pixels “S23g” and “S21o” is mixed with the oblique pixel sum so as to output the interpolation signal S121, as shown in FIG. 6, then such a light gray picture caused by the pixel “S22g” is displayed on a portion of the video, which should be originally displayed in white, whereby the image quality is deteriorated.

Therefore, the mixing circuit 118 functions as the oblique pixel detecting unit. When it is detected that the interpolation pixel “S22k” is formed by employing only the two oblique pixels as above, the mixing circuit 118 outputs the interpolation signal S121 without mixing the upper/lower interpixel sum including one of two oblique pixels corresponding to this detection result of the pixel S22K. (Namely, mixing of upper/lower interpixel sum including the oblique pixels is canceled).

Accordingly, it is possible to avoid the interpolation pixel “22g” being displayed in the light gray as shown in FIG. 6, so that deterioration of the image quality is prevented.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video signal oblique interpolating apparatus for interpolating data at intermediate pixels between upper pixels and lower pixels, the upper pixels driven by a video signal, the lower pixels driven by a delayed signal of the video signal, the apparatus comprising:
an oblique direction determining unit configured to determine a maximum correlation direction at an intermediate pixel, the maximum correlation direction being a direction from one of the upper pixels to one of the lower pixels via the intermediate pixel, the one of upper pixels and the one of lower pixels which are positioned symmetrical about the intermediate pixel and whose data show a maximum correlation;
an upper/lower oblique correlation detecting unit configured to calculate an upper oblique correlation and a lower oblique correlation, the upper oblique correlation being calculated between data of an immediate upper pixel and data of a corresponding lower pixel, the immediate upper pixel positioned at an immediate upper side of the intermediate pixel, the corresponding lower pixel positioned downward in the maximum correlation direction with respect to the immediate upper pixel, the lower oblique correlation being calculated between data of an immediate lower pixel and data of a corresponding upper pixel, the lower pixel positioned at an immediate lower side of the intermediate pixel, the corresponding upper pixel that is positioned upward in the maximum correlation direction with respect to the immediate lower pixel;
a vertical correlation detecting unit that detects a vertical correlation between the data of the upper pixels and the data of the lower pixels;
an interpolation signal outputting unit configured to output an interpolation signal with respect to the intermediate pixel, the interpolation signal obtained by mixing an oblique pixel sum and a vertical pixel sum, the oblique sum obtained by summing data of the one of upper pixel and the one of lower pixel, the vertical pixel sum obtained by summing data with respect to the immediate upper pixel and the immediate lower pixel, while changing mixing ratio of the oblique pixel sum and the vertical pixel sum based on comparison result of the vertical correlation, the upper oblique correlation and the lower oblique correlation; and
an oblique pixel detecting unit configured to detect whether the interpolation signal is constituted by the oblique pixel sum without the vertical pixel sum;
wherein the interpolation signal outputting unit generates an interpolation signal with respect to at least one of intermediate pixels that are positioned at an immediate upper side of the corresponding lower pixel and at an immediate lower side of the corresponding upper pixel, excluding a vertical pixel sum that includes data of the corresponding lower pixel and/or data of the corresponding upper pixel, when the oblique sum detecting unit detects that the interpolation signal is constituted by the oblique pixel sum without the vertical pixel sum.

2. The video signal oblique interpolating apparatus as claimed in claim 1,
wherein the interpolation signal output unit outputs the interpolation signal by mixing the first oblique pixel sum and the second oblique pixel sum more preferentially over the vertical pixel sum, as the upper oblique correlation and the lower oblique correlation become larger as compared to the vertical correlation.

3. The video signal oblique interpolating apparatus as claimed in claim 1, further comprising:
a delay signal array generating unit configured to generate delay signal arrays based on the video signal and the delayed signal;
wherein the upper/lower oblique correlation detecting unit calculates the upper oblique correlation and the lower oblique correlation based upon the delay signal arrays.

4. The video signal oblique interpolating apparatus as claimed in claim 3,
wherein the vertical correlation detecting unit detects the vertical correlation based on the delay signal arrays.

5. The video signal oblique interpolating apparatus as claimed in claim 1, further comprising:
a display control unit configured to control a display of a video based on the interpolation signal.

6. The video signal oblique interpolating apparatus as claimed in claim 1, further comprising:
a display unit configured to display a video based on the interpolation signal and the video signal.

7. A video signal oblique interpolating method for interpolating data at intermediate pixels between upper pixels and lower pixels, the upper pixels driven by a video signal, the lower pixels driven by a delayed signal of the video signal, the method comprising:
determining a maximum correlation direction at an intermediate pixel, the maximum correlation direction being a direction from one of the upper pixels to one of the lower pixels via the intermediate pixel the one of upper pixels and the one of lower pixels which are positioned symmetrical about the intermediate pixel and whose data show a maximum correlation;
calculating an upper oblique correlation and a lower oblique correlation, the upper oblique correlation being calculated between data of an immediate upper pixel and data of a corresponding lower pixel, the immediate upper pixel positioned at an immediate upper side of the intermediate pixel, the corresponding lower pixel positioned downward in the maximum correlation direction with respect to the immediate upper pixel, the lower oblique correlation being calculated between data of an immediate lower pixel and data of a corresponding upper pixel, the lower pixel positioned at an immediate lower side of the intermediate pixel, the corresponding upper pixel that is positioned upward in the maximum correlation direction with respect to the immediate lower pixel;
detecting a vertical correlation between the data of the upper pixels and the data of the lower pixels;
outputting an interpolation signal with respect to the intermediate pixel, the interpolation signal obtained by mixing an oblique pixel sum and a vertical pixel sum, the oblique sum obtained by summing data of the one of upper pixel and the one of lower pixel, the vertical pixel sum obtained by summing data with respect to the immediate upper pixel and the immediate lower pixel, while changing mixing ratio of the oblique pixel sum and the vertical pixel sum based on comparison result of the vertical correlation, the upper oblique correlation and the lower oblique correlation; and
detecting whether the interpolation signal is constituted by the oblique pixel sum without the vertical pixel sum;
wherein an interpolation signal is generated with respect to at least one of intermediate pixels that are positioned at an immediate upper side of the corresponding lower pixel and at an immediate lower side of the corresponding upper pixel by excluding a vertical sum that includes data of the corresponding lower pixel and/or data of the corresponding upper pixel, when the interpolation signal is constituted by the oblique pixel sum without the vertical pixel sum.
